(19) United States
(12) Patent Application Publication
(10) Pub. No.: US 2023/0268777 A1
(43) Pub. Date: Aug. 24, 2023

(54) Electric Vehicle Wireless Radio Frequency Battery Charger

(71) Applicant: GREGORY D'OLIVEIRA HENRY, West Organe, NJ (US)

(72) Inventor: GREGORY D'OLIVEIRA HENRY, West Organe, NJ (US)

(21) Appl. No.: 17/676,263

(22) Filed: Feb. 21, 2022

(51) Int. Cl. H02J 50/20; B60L 53/60

(52) U.S. Cl. CPC H02J 50/20; B60L 53/60; B60M 7/003

(57) ABSTRACT

An enhanced wireless electric vehicle battery powering and recharging system technology, through the method of a wireless radio frequency (RF) signal once the vehicle power is switched on. The invention can be installed in a stand alone structure, in a partial or fully electric land, air, or water vehicles, to power or recharge the battery system. This invention will extend a vehicle's travel distance before or without stopping and connecting to fossil fuel or other stationary rechargeable power sources. This electric vehicle wireless electric generator is an additional battery charging technology that will support any partial or fully electric-powered vehicle. The invention can be installed as a hardware component with software program, without any interference with existing electric vehicle electronic components or battery charging systems.

### PRIORITY

This application does not claims any domestic benefit from pending provisional application.

### FIELD OF INVENTION

The present invention relates to the field of battery charging system for electric vehicles (EV), specifically for wireless electrical charging system for extending the storage power in a fully or partial electric vehicle battery system for longer distance and travel time.

### BACKGROUND

Every year government is constantly looking for ways to tackle vehicle fuel emission. By 2025 it is predicted that 30% of the vehicle sales will be of partial or fully electric powered vehicles. The main challenge is to create electric vehicles that can travel longer distances without needing to be stopped for a recharge from a stationary power source that may be powered by a fossil fuel powering system ever so often.

Adding a new advance electric vehicle wireless radio frequency (RF) electrical charging system would be extremely beneficial to the existing and future partial or fully electric powered vehicles. This is specifically for the extension of the travel distance before the vehicle needed to be stopped and be connected to a power source for a recharge. A method for an electric vehicle wireless RF electrical charging system to allow for a partial or fully electric powered vehicle to travel at a longer distance, without the need to stop for recharge has been addressed in multiple prior patents. However, those prior patents are recognized as methods of a resonant coils and antenna, non-contact coil, and braking mechanism. Current partial or fully electric vehicle battery charging system designs and functions may be very useful, but are not implemented in the most efficient manner. This new invention will solve that problem, because of its application and its zero resistance on the vehicle drive functions.

U.S. Pat. No. 8,860,362 discloses the use of a system for charging a battery within a partially electric vehicle. U.S. Pat. No. 5,635,817 discloses an emergency vehicle battery charging device is utilized to charge a depleted battery of a first vehicle from the engine system of a running second vehicle at a determined maximum charging current above that use for a trickle charge and below the typical starting current of either vehicle.

There are also other partial or fully electric powered vehicle battery charging technologies which are disclosed in U.S. Pat. No. 5,487,956 and 20130175987. These prior art patents disclose technologies that are relevant to the current invention, which presents a unique combination of several existing technologies.

Some of these existing devices and/or technologies that are implemented in current electric vehicle's battery charging system of inventions include: Wireless, resonant device, electromagnetic field, conduction plates or coil assembly (U.S. Pat. Nos. 20100277121, 20110109262 and 10,086,715); An inductive charging of a rechargeable battery of a vehicle and or its components (U.S. Pat. Nos. 20120200254 and 7,208,912); Charging module and rechargeable battery assembly for electric vehicle and System and method for recharging electric vehicle batteries (U.S. Pat. Nos. 9,543,783 and 8,587,253); Detecting a wireless charging-capable vehicle through a top and bottom coil (U.S. patent Ser. No. 10/086,715); A wireless charging apparatus with detector adjusted in inclination of an electric vehicle (U.S. patent Ser. No. 10/399,449); A vehicle non-contact device controls power supply with a ground-side power supply section outside of a vehicle (U.S. Pat. No. 20120200151); Electrical wiring harness structure for vehicle (U.S. Pat. No. 5,623,169).

### SUMMARY OF THE INVENTION

The invention herein presented new features of enhancement of known technologies. The invention is designed to work across existing electric vehicle battery powering platforms of partial or fully electric powered vehicles. The invention utilizes existing electronic and battery charging technologies to charge internal standalone structure or vehicle battery system. Components or features for making the partial or fully electric-powered vehicle battery charging system, charge the battery as required by the vehicle internal battery. An automobile wireless RF electrical charging system can be added to a partial or fully electric-powered vehicle battery charging system.

The present invention represents a dynamic improvement to existing partial or fully electric powered vehicle battery charging technologies. The invention utilizes standard electronic components and battery charging technologies which allows a partial or fully electric powered vehicle battery to be recharge without stopping for a recharge. An advantage of this automobile wireless RF electrical charging system is the dependency on the use of fossil fuel to recharge the batteries of partial or fully electric vehicles.

This new partial or fully electric vehicle wireless RF electrical charging system is brought about by the application of additional advance vehicle battery recharging technical features. These features are designed to be installed and operate with existing battery charging technologies in partial or fully electric powered vehicle. The partial or fully electric vehicle wireless RF electrical charging system is activated by the reprogrammed and transmitted radio frequency from a transmission antenna, a satellite antenna or from a vehicle on board radio frequency signal generator. The RF wireless signal of the transmission antenna, satellite antenna or the vehicle on board radio frequency signal generator will cause the onboard RF signal receiver and power amplifier to power the voltage regulator. This will then power the electric vehicle battery charging system use for the recharging of the existing electric vehicle batteries.

A preferred embodiment of the invention uses conventional RF signal transmitter, electricity generation technology and battery charging electronic circuitry, which operates through the transmitting and the receiving of reprogrammed radio frequency. The electric vehicle wireless RF signal electrical charging system is activated by the reprogrammed and transmitted radio frequency signal from a transmission antenna, a satellite antenna or from the vehicle on board radio frequency signal generator. This electric vehicle wireless RF powered electric charging system will allow the partial or fully electric vehicle battery to be charge as is known in the art.

Allowing the battery system in a partial or fully electric powered vehicle with a wireless RF powered electric generator to recharge the electric vehicle batteries, for the purpose of longer travel distances. This new automobile battery charging system will prevent the electric vehicle from being connected to a fossil fuel generating power source. Similarly, the electric powered vehicle wireless RF powered electric generating system will help to reduce the increase of dangerous green house gas, and promote a safer carbon foot print. The electric powered vehicle with a wireless RF powered electric generator can recharge the batteries in an electric vehicle to reduced the need for the use of fossil fuel power system, unless absolutely necessary.

For partial or fully electric powered vehicle which does not have this new wireless RF powered electric generator system installed by a the vehicle manufacturer. The system will be able to be installed by qualified installer. This will allow any partial or fully electric vehicles manufactured prior to the implementation of this new invention to take advantage of this carbon foot print and green house gas reduction technology. This before or aftermarket installation of the new partial or fully electric powered vehicle with a wireless RF powered electric generating system for recharging the vehicle batteries can prevent the rapid recycling of prior partial or fully electric vehicles, unless absolutely necessary.

The partial or fully electric powered vehicle with a wireless RF powered electric generation system software for this new invention if applicable will include advanced security encryption features, to prevent unauthorized access by unauthorized system. Advance security features are desirable, because as the new wireless RF battery recharging technology is designed to be used in conjunction with other existing vehicle battery charging technologies, software security will be vital.

### BRIEF DESCRIPTION OF THE DRAWINGS

FIG. 1 is a block diagram of the present invention.

### DETAILED DESCRIPTION OF THE PREFERRED EMBODIMENT

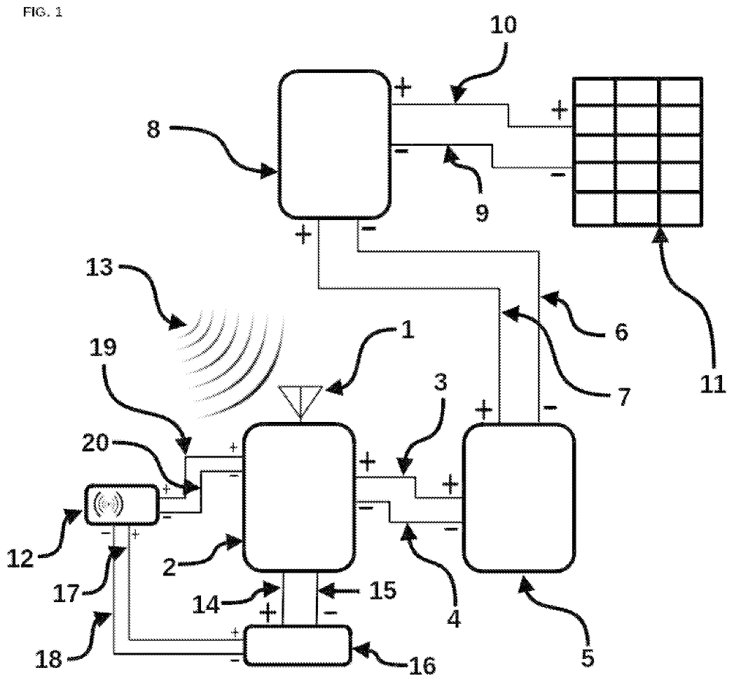

In FIG. 1 the electric vehicle wireless battery range extending system contains the radio frequency signal component 13, where the wireless RF signal component 13 enter the EV onboard radio frequency receiver antenna of device 1. Antenna device 1 the pathway for the wireless RF signal of the RF receiver and power amplifier of device 2, where device 2 is powered through connecting leads devices 14 and 15, to the existing vehicle electric power of object 16, over the negative wire connection of object 15 and the positive wire connection of object 14, where the RF receiver and power amplifier system device 2 causes the electric power amplification through device 5, where the transmission of electric power through connecting leads devices 3 and 4. The negative connection device 4, and the positive connection device 3, which are the connection leads to device 5, where voltage regulator system device 5 causes the electric power transmission through connecting leads devices 6 and 7. The negative connection device 6, and the positive connection device 7, which are the connection leads to device 8, where device 8 is the existing vehicle battery charging system. The existing vehicle battery system device 8 transmits electric power through connecting leads devices 9 and 10. The negative connection device 9, and the positive connection device 10, which are the connection leads to device 11, where device 11 is the existing vehicle battery system. The onboard frequency or tone generating and transmitting device 12, where device 12 is use as a backup when or if device 13 the radio frequency from aerial transmitter is not available, device 12 causes backup RF signal transmission through connecting leads devices 19 and 20. The negative connection device 20, and the positive connection device 19, which are the connection leads to device 2 the EV onboard RF receiver and power amplifier, which is equipped with receiving antenna of object 1. Where device 12 is powered through connecting leads devices 17 and 18. The negative connection device 18, and the positive connection device 17, which are the connection leads to device 16 the existing EV power supply. The RF receiver and power amplifier system device 2 and receiving antenna of object 1 is powered through connecting leads devices 14 and 15. The negative connection device 15, and the positive connection device 114, which are the connection leads to device 16 the existing EV power supply. Once the electric vehicle on o start button is switched on. The per-program radio frequency will starts transmitting from RF aerial antenna to the electric vehicle's onboard radio frequency receiver and power amplifier. If there are no external aerial RF transmission available then the EV onboard radio frequency transmitter will transmit the RF signal to the EV onboard RF receiver and power amplifier. Then the amplified electric power will be transmitted through the connection leads to the voltage regulator. The electric power from the voltage regular will then be transmitted through the leads to the existing EV battery charger to charge the existing vehicle battery system. The battery power will then be use to operate the moving vehicle for a longer travel time period before needing to be connected to a fossil fuel electric system or to any other external electric charging system. This electric powered vehicle could be of either land, air or water.

Once the wireless RF electric vehicle battery range extending system in FIG. 1 is installed in a stand alone structure, air, land or water vehicle, and the vehicle power is switched on then object 13, the RF transmitter signal will cause object 2 equipped with RF receiving antenna object 1, the EV onboard RF receiver and power amplifier which is powered by the existing vehicle power of object 16, over the negative wire connection of object 15 and the positive wire connection of object 14, will be activated and then transmit the electric power over the negative wire connection of object 4 and the positive wire connection of object 3, to the voltage regulator of object 5, will then transmit electric power over the negative wire connection of object 6 and the positive wire connection of object 7, to the vehicle existing battery charger of object 8, which will then transmit electric power over the negative wire connection of object 9 and the positive wire connection of object 10 to the existing EV battery of object 11. If the RF of object 13 is not available, then the EV onboard RF signal transmitter of object 12, which is powered by the existing vehicle power of object 16, over electric power of the negative wire connection of object 18 and the positive wire connection of object 17, will then transmit the RF electric power over the negative wire connection of object 20 and the positive wire connection of object 19, to the EV onboard RF receiver and power amplifier of object 2, equipped with RF receiving antenna of object 1. Once the vehicle power is switched on, and the EV wireless RF battery charging system is activated the existing vehicle battery charging will start. The vehicle will then be able to travel for longer distance with a constant charge, causing the vehicle to use less fossil fuel for recharging during travel. This will leads to a tremendous reduction in greenhouse gas and other known environmental pollution.

Using the EV wireless RF battery charging system in FIG. 1, the moving vehicle will obtain sustainable electric power from the existing vehicle battery device 8 to sustain the vehicle travel distance. A great sustainable and economical way for powering a stand alone structure, an air, land or water vehicle.

The EV wireless RF battery charging system in FIG. 1 comprises an EV radio frequency receiver and power amplifier device 2 which is equipped with RF receiving antenna device 1. Voltage regulator device 6 is preferably equipped with advance high voltage sensing system for the optimal operation of the EV wireless RF battery charging system.

The inventive device will be constructed from existing materials, components, and with available technologies. The cost is predicted to be minimal and acceptable in value.

Advantages of the present invention include but not limited to: electric power generation cause by the EV wireless RF battery charging system whenever the equipped vehicle starts up, greater vehicle travel distance and a reduction for the use of fossil fuel for electric vehicle battery recharging, and also a reduction to green house gas and other environmental pollution.

While certain novel features of the present invention have been shown and described, it will be understood that various omissions, substitutions and changes in the forms and details of the device illustrated and in its operation can be made by those skilled in the art without departing from the spirit of the invention.

I claim:

1. A method for the charging of the existing battery system in partial or fully electric powered vehicle with a wireless RF electric power generation system installed in a stand alone structure, an air, land, water vehicle and comprising of:
generation of a first electric vehicle power is by the wireless RF electric power generator of the equipped vehicle.
identification of the electric vehicle utilizing the wireless RF electric power generation battery charging or powering technology.
identification of the electric vehicle utilizing a wireless RF electric power generator as a RF signal receiver and electric power amplifier.
receiving of radio frequency signal from the electric vehicle wireless RF electric power generator is use for the amplification of power to the voltage regulator.
power received by the voltage regulator will be transmitted to the existing electric vehicle battery charging system.
power from the existing electric vehicle battery charging system will be transmitted to the existing battery system for continuous charging while the electric vehicle is switched on.
radio frequency signal from the external or onboard RF transmitter and received by the wireless RF receiver and electric power amplifier generates power for the electric vehicle existing battery system.
electricity from the vehicle wireless RF electric power generator is transmitted over negative and positive wire connections.
absence of a wireless RF signal will be supported and or backed up by the onboard RF signal generator for the continuous operation of the electric vehicle and or stand alone structure battery charging system.
generated wireless RF electric power is use to power the electric vehicle to travel for longer duration without stopping for battery recharging.

2. A method of claim 1, further comprising:
electricity generation by the receiving of wireless RF signal by the vehicle for the main purpose of powering or recharging of the existing electric vehicle battery system.

3. A method of claim 1, where the wireless RF electric power generation is caused by the receiving of a RF signal by the equipped vehicle once it is switched on and continues in progress until the vehicle power is switched off or until the vehicle battery is fully charged.

4. A method of claim 1, where the electric power of the first vehicle is generated from the wireless RF receiver or the onboard RF signal transmitter and power amplifier of the vehicle, which comprises of an electricity generation and transmission to an existing electric vehicle battery system.

5. A method of claim 1, further comprising:
using RF signal receiver and power amplifier in the electric vehicle, mainly for powering, charging and extending the electric power and travel distance of the electric vehicle.

6. A method for allowing an electric vehicle to receive electric power from a vehicle RF signal receiver, a power amplifier and electric power generation technology system comprising:
a wireless RF signal receiver, power amplifier and electric power generator and a existing electric vehicle battery powering system, this device is capable of generating and transmitting electric power through the voltage regulator to the electric vehicle existing battery charging and power system.
software and hardware for the function of the electric vehicle wireless RF signal receiver, power amplifier and the electric power system.
advance sensors and monitoring technologies implemented as a major feature to the functioning of the electric vehicle wireless RF signal, power amplifier and electric power generating system.
after the RF signal is received by the receiver and then amplified by the power amplifier and transmitted through the voltage regulator to the vehicle battery charger for the purpose of recharging the battery.
a constant generation of wireless RF electric power will be in progress and termination of the electric vehicle wireless RF electric power will occur once the vehicle power is switched off.
connection of the new vehicle wireless RF electric power generating system to the existing electric vehicle battery system will improve the capabilities of the vehicle battery system.
connection to the existing electric vehicle battery system will be just as other vehicle battery charging system are connected without any disruption to the any function of the existing vehicle battery power system.
